(19) United States
(12) Patent Application Publication
(10) Pub. No.: US 2005/0136982 A1
(43) Pub. Date: Jun. 23, 2005

(54) Dialing device for a cell phone used in a vehicle

(76) Inventor: Shih-Hsiung Li, Taipei (TW)

Correspondence Address: Troxell Law Office PLLC, Suite 1404, 5205 Leesburg Pike, Falls Church, VA, 22041, US

(21) Appl. No.: 10/736,638

(22) Filed: Dec. 17, 2003

(51) Int. Cl. H04M 1/00; H04B 1/38

(52) U.S. Cl. 455/564; 455/565

(57) ABSTRACT

A dialing device is used in company with a cell phone in a vehicle, wherein the driver writes down on a handwriting device a name or a number of a person to be telephoned. After a control unit identifies the written data, the control unit actuates a miniature projector to project an image on a windshield. Therefore, by directly reviewing the windshield, the car driver can easily check whether the name or the number to be dialed is correct without stopping looking at the road ahead.

### BACKGROUND OF THE INVENTION

1. Field of the Invention

The present invention relates to a dialing device, and more particularly to a dialing device that allows a driver of a vehicle to dial the cell phone in the vehicle by handwriting.

2. Description of Related Art

In order to prevent possible traffic accidents resulting from the use of cell phones when people are driving, a preferable way to dial a number on a cell phone is accomplished by speech recognition dialing. When people attempt to call someone while driving, the call can be easily initiated just by speaking the name of the person to be called. The cell phone will recognize the spoken name, locate the name and number in its memory and automatically dial the correct number. However, the aforementioned way still has some problems as follow.
1. Limited by the storage capacity in the cell phone, the recordable amount of the numbers is also limited.
2. It is common for a lot of background noise, such as engine sound, to exist in a vehicle so when people are dialing the accuracy of voice recognition may be impaired and thus the attempt to make the call might fail.
3. The human voice may have a temporary hoarseness and differ from the usual tone, especially when a person has an inflammation in the throat or has caught a cold.

Another way to dial is through the use of a touch-panel or a handwriting panel. The driver only needs to write down the phone number on the panel. Since written numerals can be easily recognized, it is easy to achieve a successful call. However, when writing the number on the panel, it is necessary to lower the head when writing so as to check if the written number is correct and this may result in a possible accident.

### SUMMARY OF THE INVENTION

The main objective of the present invention is to provide a dialing device that allows the driver to safely dial a telephone call by handwriting the appropriate number while the driver is driving the vehicle.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a dialing device in accordance with the present invention;

FIG. 2 shows a schematic image that is projected on a windshield of a car in accordance with the present invention;

FIG. 3 is an operational view of the dialing device of the present invention; and

FIG. 4 is another operational view of the dialing device of the present invention.

### DETAILED DESCRIPTION OF THE PREFERRED EMBODIMENT

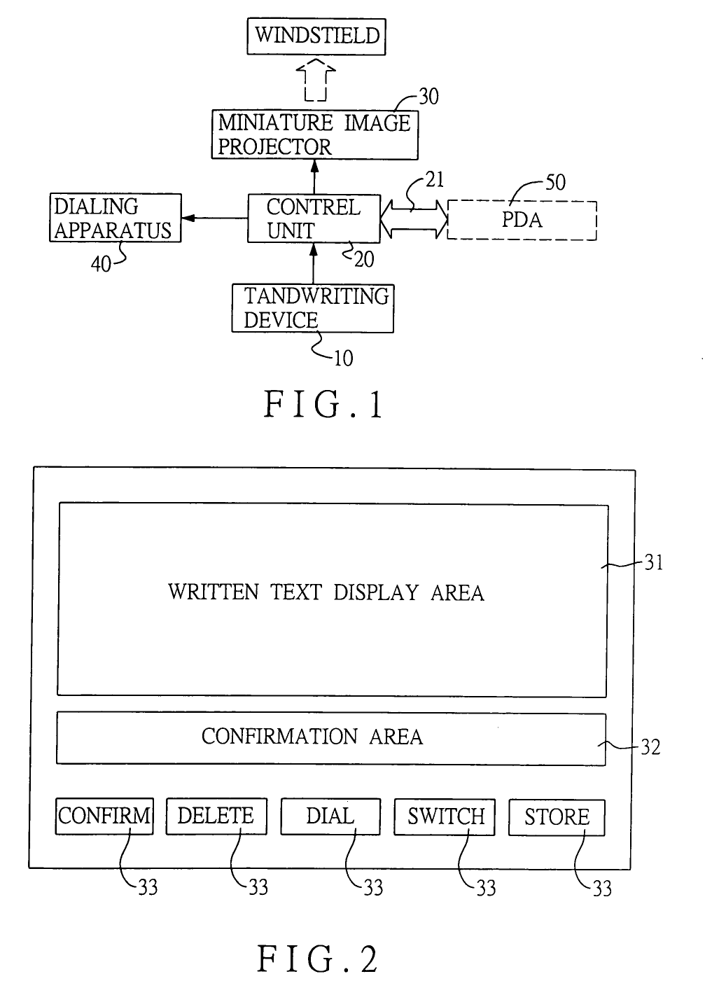

With reference to FIG. 1, a dialing device in accordance with the present invention mainly includes a handwriting device (10), a control unit (20), a miniature projector (30), a dialing apparatus (40) and a connecting interface (21).

The handwriting device (10) is provided to receive a written number from a user or driver, wherein the handwriting device (10) may be performed by a touch type panel or a handwriting panel. The touch type panel is used in the embodiment hereinafter.

The control unit (20) has a penmanship recognition system fitted inside. The penmanship recognition system is able to identify characters or numbers written on the handwriting device.

The miniature projector (30) connected to the control-unit (20) can generate and project an image on a windshield of a vehicle such as a car. The projected image is illustrated in FIG. 2. The image is composed of several regions, which include a written text display region (31) showing all texts written by the driver, a confirmation region (32) showing the recognized text result, and a plurality of function keys (33). The function keys (33), for example, include “confirmed”, “delete”, “dial”, “switch” and “store”. The explanation for these function keys (33) will be disclosed in detail later.

Still referring to FIG. 1, the dialing apparatus (40) serves as an interface between the control unit (20) and a cell phone. After the driver confirms the number displayed on the image is correct, the driver dials the confirmed number on the cell phone through the dialing apparatus (40).

The connecting interface (21) is for connection between the control unit (20) and an electrical apparatus such as a personal digital assistance (PDA) (50) or a notebook computer. Therefore, data can be downloaded from or uploaded to that electrical apparatus. It is noted that the connecting interface (21) is either a wire-connected type or a wireless type. If the connection interface (21) is a wire-connected type interface, it may be a USB, an RS232 port etc. Otherwise, the wireless type for the connecting interface (21) may be an infrared port or a Bluetooth™ transmission port.

From the above description, the basic configuration and function of the invention are disclosed. In the following disclosure, the detail operation and function for each element will become more clear when taken in conjunction with the accompanying drawings.

The touch-type handwriting device (10) has sensing ability to receive the written text. The written text to be recognized is then transmitted to the control unit (21). Since the present handwriting recognition technology has become well developed, it is easy to acquire a high recognition accuracy. Moreover, when the control unit (20) achieves a connection to the PDA (50) through the connection interface (21), the data stored in the PDA (50) is also accessible by using the handwriting device (10).

When the control unit (20) detects hand-written data from the handwriting device (10), all the detected written data is projected as an image on the windshield of the car. At the same time, the hand-written data will be compared to the existing words stored in the control unit (20) thus finding the most similar characters. In the same way as the well known handwriting system, the control unit (20) possesses a self-learning ability, which memorizes the user's particular script and enables the control unit (20) to achieve high recognition accuracy within a short term.

The control unit (20) not only can recognize numbers, but also can identify characters such as letters so that if the written data is a name of a person to be called, the control unit (20) still can recognize that name and locate a corresponding number to be dialed.

The projected image display on the windshield from the miniature projector (30) provides a checking function for the user to verify whether the recognized result is correct. As mentioned above, two regions (31) (32) respectively display the written text and the recognized result. If the recognized data on the confirmation region (32) is correct, the user can move a cursor of the handwriting device (10) to the function key “confirmed” and perform actuation at that position. When the function “confirmed” is actuated, the text on the confirmation region (32) is accepted. Otherwise, if the data displayed on the confirmation region (32) is wrong, the incorrect word can be deleted just by actuating the “delete” function key. After all the numerals have been correctly recognized, the driver actuates the “dial” function to instruct the control unit (20) to dial the designated number through the dialing apparatus (40).

The driver may suddenly attempt to record some information during driving. In this situation, the driver can utilize the handwriting device (20) to write down desired information. When the “store” function key is actuated, this written information can be selectively stored in the control unit (20) or sent to the PDA (50) connected to the control unit (20).

The driver is able to operate the PDA (50) by actuating the “switch” function key. At the same time, the image on the windshield from the miniature projector (30) is the same as that on the display screen of the PDA (50).

When the “dial” key is actuated, the control unit (20) dials the confirmed number through the dialing apparatus (40) to which the cell phone is connected.

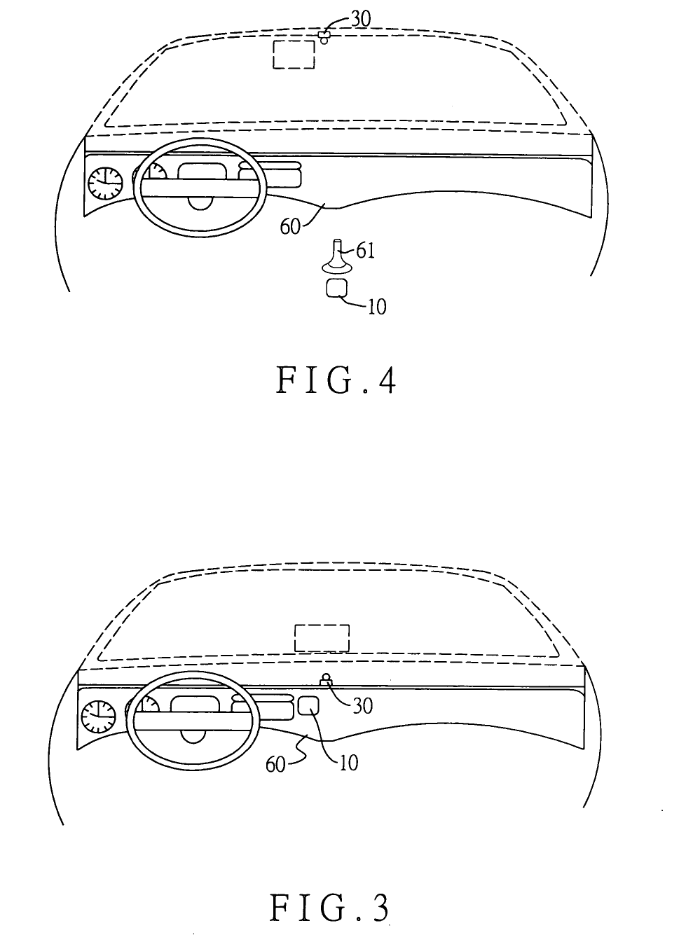

When the dialing device of the present invention is fitted in the car, the handwriting device (10) and the control unit (20) are integrated into the dashboard (60) as shown in FIG. 3, or disposed near the hand brake (61) or the gear stick as shown in FIG. 4. The miniature projector (30) can be mounted on the dashboard (60) or to the ceiling. Since the projected image only occupies a small region of the windshield, there is no obstruction to the driver's field of view.

Moreover, by updating the program in the control unit (20), the display mode may have more auxiliary functions. For example, for a vehicle equipped with a display monitor, the video signal output from the control unit (20) can directly displayed on that monitor.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A dialing device for a cell phone used in a vehicle, the dialing device comprising:
a handwriting device receiving handwritten data;
a control unit, which identifies the most similar words to the handwritten data and outputs a video signal;
a miniature image projector, which is connected to the control unit and projects an image based on the video signal from the control unit on a windshield of the vehicle to display a telephone number; and
a dialing apparatus, wherein the control unit connects to the cell phone through the dialing apparatus, when the telephone number displayed on said image is confirmed, the dialing apparatus starts to dial the confirmed telephone number.

2. The dialing device of claim 1, wherein the image projected on the windshield is composed of several regions that include:
a written text display region, which displays the handwritten data received by the handwriting device;
a confirmation region, which displays the most similar words recognized by the control unit; and
a plurality of function keys including a “confirmed”, “delete”, “dial”, “switch” and “store”.

3. The dialing device of claim 2, the control unit further connects to a connecting interface to which a personal digital assistance (PDA) or a notebook computer is connected.

4. The dialing device of claim 3, wherein when the “switch” function key on the image is actuated, the projected image on the windshield is switched to a display screen as shown on the PDA or the notebook computer.

5. The dialing device of claim 4, wherein said connecting interface is a wire-connected type interface.

6. The dialing device of claim 5, wherein said connecting interface is a USB port.

7. The dialing device of claim 5, wherein said connecting interface is an RS232 port.

8. The dialing device of claim 4, wherein said connecting interface is a wireless transmission interface.

9. The dialing device of claim 8, wherein said connecting interface is an infrared port.

10 The dialing device of claim 1, wherein the handwriting device is a touch panel.

11 The dialing device of claim 1, wherein the handwriting device is a handwriting panel.
